(19) United States
(12) Patent Application Publication
(10) Pub. No.: US 2017/0132898 A1
(43) Pub. Date: May 11, 2017

(54) METHOD OF DETECTION BY A TERMINAL OF A PRESENCE SIGNAL, SYSTEM AND DEVICE ASSOCIATED THEREWITH

(71) Applicant: GROUPEER TECHNOLOGIES, PARIS (FR)

(72) Inventors: SÉBASTIEN TREMEY, CORMEILLE EN PARISIS (FR); GILLES TREMEY, SURESNES (FR)

(21) Appl. No.: 15/318,958

(22) PCT Filed: Jun. 17, 2015
(86) PCT No.: PCT/EP2015/063586

§ 371 Date: Jan. 3, 2017

(30) Foreign Application Priority Data
Jun. 20, 2014 (FR) 1455694

(51) Int. Cl. G08B 21/02

(52) U.S. Cl. CPC G08B 21/0247; G08B 21/0238; G08B 21/0227

(57) ABSTRACT

A method for detecting by a master terminal of at least one emission of a presence signal by at least one supervision terminal. At least one supervision terminal is paired with the master terminal. Each supervision terminal paired with the master terminal emits the presence signal at a predetermined frequency. The master terminal detects the presence signal emitted by each supervision terminal paired with the master terminal. A power of the presence signal from each supervision terminal detected is compared with at least one predetermined limit value. A user of the master terminal is informed of the power of the presence signal from at least one supervision terminal which is lower than at least one predetermined limit value.

### FIELD OF THE INVENTION

The present invention targets a method and a system for detection, by a terminal called “master terminal”, of at least one emission of a presence signal by at least one terminal called “supervision terminal”, and a group supervision terminal called “master terminal”.

More particularly, the present invention applies to the field of communication between several devices, notably in the case of supervision of a group of independent elements.

### STATE OF THE ART

There are a number of devices for detecting the distancing or disappearance of an object or of a living being. These devices comprise an emitter, emitting a radio signal of BLE (Bluetooth Low Energy) type interacting with a communicating portable terminal of Smartphone or digital tablet type comprising an application making it possible to determine the presence or the absence of the emitter.

These devices present a number of drawbacks, such as, for example, the limited frequency band of the BLE waves and the distance to which a BLE wave can be propagated. Furthermore, the user must have a compatible communicating portable terminal but the use of the communicating portable terminals is restricted in hospitals for example. Finally, the device depends on the battery life of the communicating portable terminal which is restricted. Furthermore, the number of emitters which can be connected to a communicating portable terminal is limited.

The patent of invention FR 2 791 452 details a device for monitoring individuals by radio frequency which comprises emitting units and a central unit. The central unit picks up signals emitted by the emitters at regular intervals and triggers an alarm when a signal from an emitter is not received. However, the emitters all operate at the same frequency which is the reception frequency of the central unit. Furthermore, the security of the link between the emitter and the central unit is very low and interference can occur.

### OBJECT OF THE INVENTION

The present invention aims to remedy all or some of these drawbacks.

To this end, according to a first aspect, the present invention targets a method for detection by a terminal called “master terminal” of at least one emission of a presence signal by at least one terminal called “supervision terminal” which comprises the following steps:
pairing of at least one supervision terminal with the master terminal,
emission by each supervision terminal paired with the master terminal of a presence signal at a determined frequency,
detection by the master terminal of the presence signal emitted by each supervision terminal paired with said master terminal,
comparison of a power of a presence signal from each supervision terminal detected with at least one predetermined limit value and
informing of a user of the master terminal of a power of a presence signal from at least one supervision terminal lower than at least one predetermined limit value.

These embodiments offer the advantage of not depending on a particular frequency typology and of not imposing the use of a Smartphone or of a digital tablet. Furthermore, the terminals can be robust to different environments and operate underground, in extreme environments, outdoors or indoors with long ranges for example. The pairing step makes it possible to create a robust link between each supervision terminal and the master terminal. The comparison with a predetermined limit value enables the user of the master terminal to modify the distance at which a supervision terminal is not considered present.

Another advantage of these embodiments is being able to pair a large number of supervision terminals with the master terminal. Furthermore, these embodiments are independent of the standard telecommunication networks such as the GSM (Global System for Mobile) and Wi-Fi (Wireless Fidelity,®) waves.

Also, given that the actions performed by the terminals are simple and not energy intensive, the battery life of the terminals can be from several days to several months. In addition, these embodiments are inexpensive.

In embodiments, the pairing step comprises a step of signaling to a user of at least one terminal of a pairing.

The advantage of these embodiments is to signal to a user of a supervision terminal or of the master terminal that the pairing with another terminal has indeed been carried out.

In embodiments, the method that is the subject of the present invention further comprises a step of collection of data required by the master terminal and obtained by at least one supervision terminal.

The collection of data by the master terminal offers the advantage of being able, at any one time, to know the location of at least one supervision terminal for example. Another example of data that can be obtained by at least one supervision terminal is a heart rate of the user of said supervision terminal or a state of the battery of said supervision terminal. Another advantage of these embodiments is to allow the master terminal to send commands to be performed by at least one supervision terminal.

In embodiments, the emission step comprises a step of retransmission, by a supervision terminal, of a presence signal emitted by another supervision terminal.

These embodiments offer the advantage of ensuring a relaying of the presence signal ensured by a supervision terminal in case of obstacle to the transmission of the presence signal directly to the master terminal.

In embodiments, the method that is the subject of the present invention further comprises a step of management of the master terminal or of at least one supervision terminal by a communicating portable terminal.

The advantage of these embodiments is to allow a user of the master terminal to manage, through a communicating portable terminal, the settings, the administration tools of the master terminal and of each supervision terminal paired with the master terminal, the information transmitted by the master terminal and each supervision terminal, and the emission of requests and of commands to the master terminal and to at least one supervision terminal, for example. All these actions can be performed without reducing the battery life of the master terminal.

In embodiments, the management step comprises a step of display of at least one information item contained in at least one presence signal detected by the master terminal.

A display of at least one information item contained in at least one presence signal enables a user to have graphic means for viewing the distance of each supervision terminal from the master terminal.

In embodiments, the presence signal from a supervision terminal is a DECT ULE (Digital Enhanced Cordless Telecommunications Ultra Low Energy) signal.

These embodiments offer the advantage of transmitting the presence signal in a form that is not energy intensive and of increasing the battery life of the terminals. Also, the range of a DECT ULE signal can be three hundred meters with a bandwidth of a megabit per second.

In embodiments, the method that is the subject of the present invention further comprises a step of establishment of a telephone call between the master terminal and at least one supervision terminal.

The establishment of a telephone call between the master terminal and at least one supervision terminal enables the user of the master terminal to contact a user of a supervision terminal when the power of the presence signal from said supervision terminal is lower than a predetermined limit value for example.

In embodiments, the presence signal from a supervision terminal comprises data collected by said supervision terminal.

The advantage of these embodiments is making it possible for the presence signal to transmit information collected by the supervision terminal such as the heart rate of the user of said supervision terminal, the state of charge of said supervision terminal, the distance from said supervision terminal to the master terminal for example.

In embodiments, the presence signal from a supervision terminal comprises redundant information.

Redundant information makes it possible to limit the errors in the context of the transmission of a presence signal with a low power for example.

In embodiments, the emission step comprises a step of encryption of the presence signal from a supervision terminal.

These embodiments offer the advantage of guaranteeing confidentiality of the information contained in the presence signal from each supervision terminal.

According to a second aspect, the present invention targets a system for detection by a terminal called “master terminal” of at least one emission of a presence signal by at least one terminal called “supervision terminal” comprising a master terminal and at least one supervision terminal, in which:

each supervision terminal comprises:
means for pairing with the master terminal and
means for emitting a presence signal at a determined frequency;

the master terminal comprises:
means for pairing with at least one supervision terminal,
means for detecting the presence signal emitted by each supervision terminal paired with said master terminal,
means for comparing a power of a presence signal from each supervision terminal detected with at least one predetermined limit value and
means for informing a user of the master terminal of a power of a presence signal from at least one supervision terminal lower than at least one predetermined limit value.

Since the advantages, aims and particular features of the system that is the subject of the present invention are similar to those of the method that is the subject of the present invention, they are not reviewed here.

According to a third aspect, the present invention targets a device for supervising groups called “master terminal” which comprises:
means for pairing with at least one supervision terminal,
means for detecting the presence signal emitted by each supervision terminal paired with said master terminal,
means for comparing a power of a presence signal from each supervision terminal detected with at least one predetermined limit value and
means for informing a user of the master terminal of a power of a presence signal from at least one supervision terminal lower than at least one predetermined limit value.

These embodiments offer the advantage of allowing a user to supervise a group of individuals via the terminal that is the subject of the present invention regardless of the environment in which the group of individuals is moving around. Furthermore, the link between a master terminal and at least one supervision terminal is robust.

### BRIEF DESCRIPTION OF THE FIGURES

Other advantages, aims and particular features of the invention will become apparent from the following nonlimiting description of at least one particular embodiment of a method and of a system for detection by a terminal called “master terminal” of at least one emission of a presence signal by at least one terminal called “supervision terminal” and of at least one particular embodiment of a group supervision terminal called “master terminal”, in light of the attached drawings, in which:

FIG. 1 schematically represents a particular embodiment of a device that is the subject of the present invention,

FIG. 2 schematically represents a particular embodiment of a supervision terminal that is the subject of the present invention,

FIG. 3 schematically represents the interactions between a master terminal, several supervision terminals and a communicating portable terminal in a particular embodiment of the system that is a subject of the present invention and

FIG. 4 schematically represents a particular embodiment of a method that is the subject of the present invention.

### DESCRIPTION OF EXEMPLARY EMBODIMENTS OF THE INVENTION

It should now be noted that the figures are not to scale.

For the rest of the document, the following definitions apply:
a terminal called “master terminal” is defined as being a communicating portable terminal which comprises processing means for each presence signal received and configured to be paired with one or more supervision terminals simultaneously,
a terminal called “supervision terminal” is defined as being a communicating portable terminal which comprises means for emitting a presence signal and configured to be paired with a single master terminal,
a presence signal is defined as being a signal comprising information identifying the supervision terminal emitting the signal, the presence signal can also comprise information concerning data collected by said supervision terminal and information concerning said supervision terminal such as a state of charge of the stand-alone power source for example.

In embodiments, the master terminal comprises means for managing configurations and parameterizations of the supervision terminals and/or control means.

In embodiments, the supervision terminal comprises means for receiving parameterizing information, configurations and commands from the master terminal.

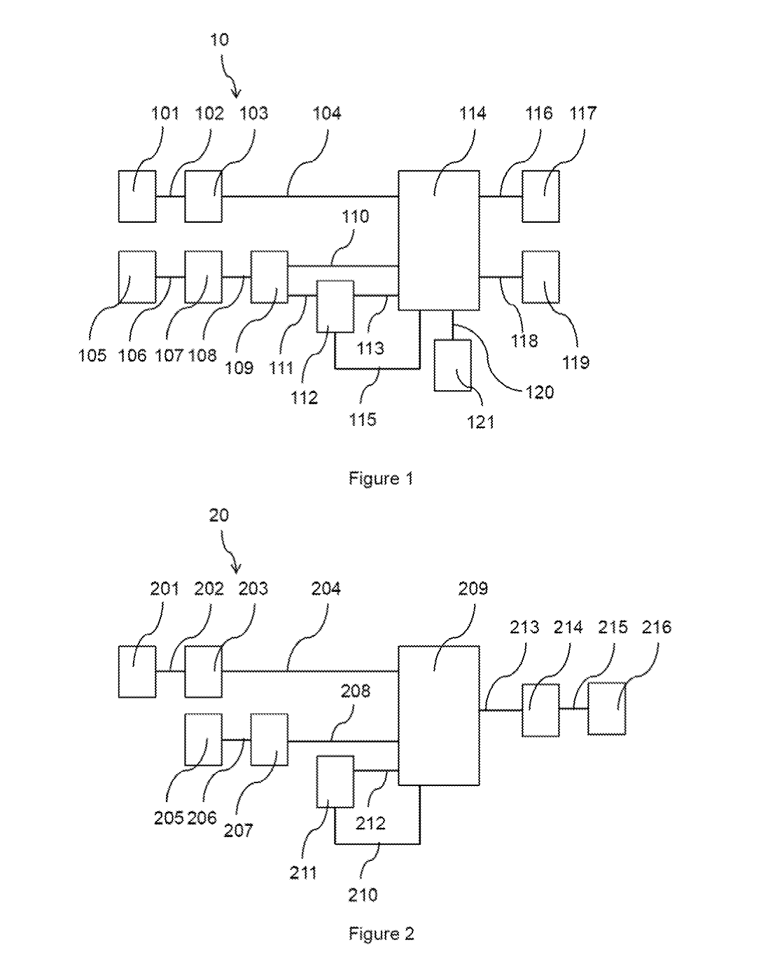

A particular embodiment 10 of a master terminal that is a subject of the present invention can be seen in FIG. 1.

In this embodiment, the master terminal 10 comprises pairing means 101. The pairing means 101 can be a key on a keypad or a button. The pairing means 101 are actuated by a user of the master terminal 10 and are configured to pair said master terminal 10 with a supervision terminal. Several supervision terminals can be paired with said master terminal 10. The pairing means 101 are configured to send to the supervision terminal with which the master terminal 10 has to be paired a public key for encryption of signals emitted by the master terminal 10 to said supervision terminal.

The pairing means 101 transmit a pairing signal 102 to the signaling means 103. The pairing signal 102 transmitted means that a pairing between the master terminal 10 and a supervision terminal has succeeded.

The signaling means 103 are configured to signal to a user that a pairing between the master terminal 10 and a supervision terminal has been successful upon reception of the pairing signal 102. The signaling means 103 are a sound signal emitter, a light emitter such as an LED (Light-Emitting Diode) or a screen displaying a signaling message for example. The signaling means 103 send a successful pairing and signaling signal 104 to control means 114.

The master terminal 10 comprises means 105 for detecting a presence signal. The detection means 105 are preferentially a modem. The detection means 105 are configured to detect each presence signal emitted by each supervision terminal paired with the master terminal 10 by means of the pairing means 101. Each presence signal detected 106 by the detection means 105 is transmitted to storage means 107. The storage means 107 are rewritable semiconductor mass memories for example. The storage of the presence signal detected can be temporary and be replaced by a subsequently detected presence signal emitted by the same supervision terminal.

Each stored presence signal 108 is transmitted to analysis means 109. The analysis means 109 analyze the stored presence signal 108 and a power of the presence signal detected by the detection means 105. The stored presence signal 108 can comprise information picked up by the supervision terminal having transmitted the presence signal. The analysis means 109 analyze and transmit to the control means 114 the information that has been picked up and analyzed 110.

The power 111 of the stored presence signal is transmitted to means 112 for comparing a power of a presence signal from each supervision terminal detected with a predetermined limit value 115. The comparison means 112 can compare the power of the signal to several predetermined limit values 115. Each predetermined limit value 115 can correspond to an area of distance from the master terminal. Several predetermined limit values 115 can be defined such that:
if the power of the presence signal is above seventy five percent of the value of the power of the initial presence signal, the user of the supervision terminal having transmitted the presence signal is considered to be in the near zone, p1 if the power of the presence signal is between fifty and seventy five percent of the value of the power of the initial presence signal, the user of the supervision terminal having emitted the presence signal is considered to be in the far zone, p1 if the power of the presence signal is lower than fifty percent of the value of the power of the initial presence signal, the user of the supervision terminal having emitted the presence signal is considered to be in the zone limit,
if the presence signal is not detected, the supervision terminal is considered absent.

The result of the comparison 113 is transmitted to the control means 114, the control means 114 being configured for the user of the master terminal to define each predetermined limit value 115 taken into account by the comparison means 112.

The control means 114 take into account the successful pairing and signaling signal 104, the information picked up and analyzed 110 and the result of the comparison 113. The control means can transmit at least a part 120 of the information to external storage means connected to the connection means 121. The connection means 121 can be an SD (Secure Digital) card reader, a micro-SD card reader, a USB (Universal Serial Bus) port, a micro-USB port, a BLUETOOTH® (registered trademark) module or any other connection means configured to connect storage means.

The control means 114 transmit at least some of the information to be displayed 116 to information means 117. The information to be displayed 116 is notably the non-reception of a presence signal from at least one supervision terminal paired with the master terminal 10. The information to be displayed is the number of supervision terminals paired with the master terminal 10 in each zone defined by at least one predetermined limit value for example. The information means are preferentially an LCD (Liquid-Crystal Display) screen or an LED (Light-Emitting Diode) screen.

The control means 114 can transmit at least one command 118 to be emitted by emission means 119 to at least one supervision terminal paired with the master terminal 10. The command to be emitted is a command to modify the emission frequency of said supervision terminal, a sound or light signal emission command, a command to detect the heart rate of the user of said supervision terminal, a command to detect the speed or the acceleration of said supervision terminal, a command to detect the level of charge of the standalone power source of said terminal for example. The emission means are an emitter of radio waves, of ultrasound, of a DECT ULE wave, for example.

The analysis means 109, the comparison means 112 and the control means 114 are microprocessors for example. The analysis means 109, the comparison means 112 and the control means 114 can be contained in a microprocessor.

A particular embodiment 20 of a supervision terminal that is a subject of the present invention can be seen in FIG. 2.

In this embodiment, the supervision terminal 20 comprises pairing means 201. The pairing means 201 can be a key on a keypad or a button. The pairing means 201 are actuated by a user of the supervision terminal 20 and are configured to pair said supervision terminal 20 with a master terminal 10. The pairing means 201 are configured to send to the master terminal 10 with which the supervision terminal 20 has to be paired a public key for the encryption of signals emitted by the supervision terminal 20 to said master terminal 10.

The pairing means 201 transmit a pairing signal 202 to the signaling means 203. The pairing signal 202 transmitted means that a pairing between the supervision terminal 20 and the master terminal has succeeded.

The signaling means 203 are configured to signal to a user that a pairing between the supervision terminal 20 and the master terminal 10 has been successful upon reception of the pairing signal 202. The signaling means 203 are a sound signal emitter, a light emitter such as an LED or a screen displaying a signaling message for example. The signaling means 203 send a successful pairing and signaling signal 204 to control means 209.

The supervision terminal 20 comprises means 205 for detecting a command emitted by the emission means 119 of the master terminal. The detection means 205 are preferentially a modem. The detection means 205 are configured to detect each control signal emitted by the master terminal 10 paired with the supervision terminal 20 by means of the pairing means 201. The detection means 205 can detect a presence signal from another supervision terminal paired with said master terminal 10 and transmit it without modifications to the emission means 216.

Each command signal detected 206 by the detection means 205 is transmitted to analysis means 207. The analysis means 207 analyze the command signal detected 206. The command signal detected 206 is a command to modify the emission frequency of said supervision terminal 20, a sound or light signal emission command, a command to detect the heart rate of the user of said supervision terminal, a command to detect the speed or the acceleration of said supervision terminal, a command to detect the level of charge of the standalone power source of said supervision terminal 20, an establishment of a telephone call with the master terminal 10, for example. The analysis means 207 analyze and transmit to the control means 209 the commands detected and analyzed 208.

The control means 209 take into account the successful pairing and signaling signal 204, the commands picked up and analyzed 208. The control means can transmit at least some 210 of the commands picked up and analyzed to at least one sensor 211. The sensor 211 can be an accelerometer, a gyroscope, a heart rate sensor, a thermometer, a barometer, an acousto-electrical transducer, for example. The supervision terminal 20 can comprise several sensors 211. The data picked up 212 by each sensor 211 are transmitted to the control means 209.

The control means 209 transmit a presence signal 213 to encryption means 214. The presence signal 213 is emitted at a predetermined frequency. The presence signal can comprise data requested by a command detected 206.

The encryption means 214 encrypt the presence signal 213 by means of the public key received by the supervision terminal 20 and emitted by the master terminal 10 in the pairing operation. The encryption can comprise a modification of the signal such that the signal comprises redundant information.

The encrypted presence signal 215 is transmitted to emission means 216. The emission means are an emitter of radiowaves, of ultrasounds, or of a DECT ULE wave, for example.

The analysis means 207 and the control means 209 are microprocessors, for example. The analysis means 207 and the control means 209 can be contained in a microprocessor.

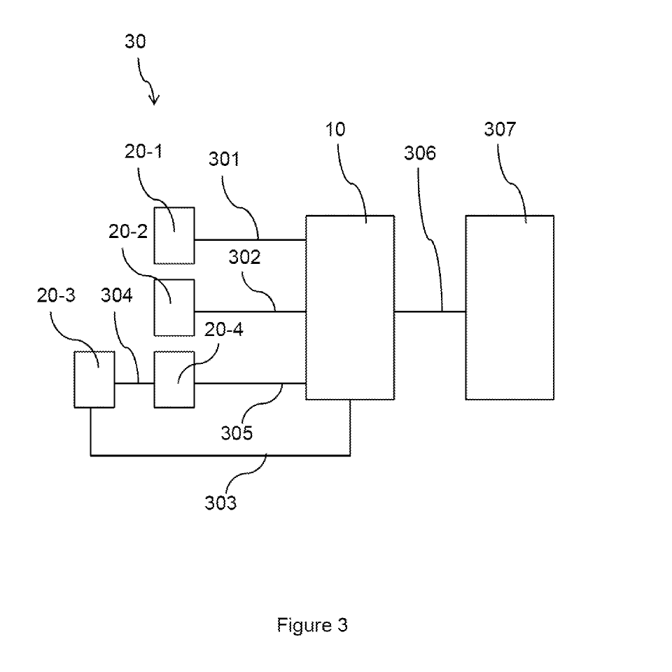

FIG. 3 shows the interactions between a master terminal 10, several supervision terminals 20-1, 20-2, 20-3, 20-4 and a communicating portable terminal 307 in a particular embodiment 30 of the system that is a subject of the present invention.

The supervision terminals 20-1, 20-2, 20-3 and 20-4 are paired with the master terminal 10. The presence signals 301 emitted by the supervision terminal 20-1 are for example emitted according to a DECT ULE signal. The presence signals 302 emitted by the supervision terminal 20-2 are for example emitted as ultrasounds.

The supervision terminal 20-3 can send presence signals 303 to the master terminal 10. In the case where the user of the supervision terminal 20-3 moves too far away from the user of the master terminal, the presence signal 303 can no longer be transmitted to the master terminal directly. A presence signal 304 can be emitted by the supervision terminal 20-3 to another supervision terminal 20-4 acting as relay. The supervision terminal 20-4 can emit a presence signal 305 comprising the presence signal from the terminal 20-3 to the master terminal 10.

A communicating portable terminal 307 can control the master terminal 10. The commands 306 sent by the communicating portable terminal 307 are commands to be transmitted to at least one supervision terminal 20-1, 20-2, 20-3, 20-4, such as: a command to modify the emission frequency of said supervision terminal, a sound or light signal emission command, a command to detect the heart rate of the user of said supervision terminal, a command to detect the speed or the acceleration of said supervision terminal, a command to detect the level of charge of the standalone power source of said terminal, an establishment of a telephone call between at least one supervision terminal 20-1, 20-2, 20-3 or 20-4 and the master terminal 10 for example.

The master terminal 10 can transfer to the communicating portable terminal 307 at least a part of the information received by the master terminal by means of at least one presence signal sent by at least one supervision terminal. The communicating portable terminal can comprise display means and display the information transferred by the master terminal 10. The communicating portable terminal 307 can control the master terminal by means of an application. The communicating portable terminal is a portable telephone of Smartphone type, a digital tablet, a digital watch or a pair of digital glasses for example.

In embodiments, the communicating portable terminal 307 comprises the master terminal 10.

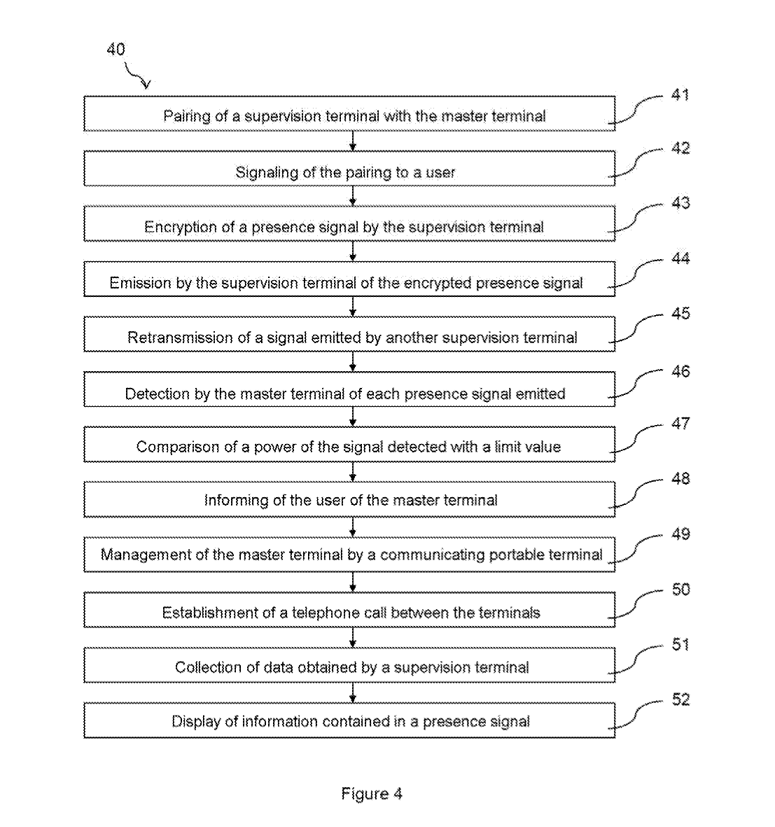

FIG. 4 shows a particular embodiment 40 of a method which is a subject of the present invention.

The embodiment 40 of the method that is a subject of the present invention comprises:
a step 41 of pairing of at least one supervision terminal with the master terminal,
a step 42 of signaling to a user of at least one terminal of a pairing,
a step 43 of encryption of the presence signal from a supervision terminal,
a step 44 of emission by each supervision terminal paired with the master terminal of a presence signal at a determined frequency,
a step 45 of retransmission, by a supervision terminal, of a presence signal emitted by another supervision terminal,
a step 46 of detection by the master terminal of the presence signal emitted by each supervision terminal,
a step 47 of comparison of a power of a presence signal from each supervision terminal detected with at least one predetermined limit value,
a step 48 of informing of a user of the master terminal of a power of a presence signal from at least one supervision terminal lower than at least one predetermined limit value,
a step 49 of managing of the master terminal or of at least one supervision terminal by a communicating portable terminal,
a step 50 of establishment of a telephone call between the master terminal and at least one supervision terminal,
a step 51 of collection of data required by the master terminal and obtained by at least one supervision terminal and
a step 52 of display of at least one information item contained in at least one presence signal detected by the master terminal.

The step 41 of pairing of at least one supervision terminal 20 with the master terminal 10 can be performed by means of the pairing means 101 and 201 of the master terminal 10 and of the supervision terminal 20 respectively. The pairing step 41 can comprise the following substeps:
switching on of the supervision terminal 20 and of the master terminal 10,
actuation of the pairing means 101 and 201 of the master terminal 10 and of the supervision terminal 20 respectively,
generation of a pairing key common to the master terminal 10 and to the supervision terminal 20,
presentation of a public pairing key from the master terminal 10 to the supervision terminal 20 and presentation of a public pairing key from the supervision terminal 20 to the master terminal 10,
memorizing by the master terminal 10 of the public key from the supervision terminal 20 and memorizing by the supervision terminal 20 of the public key from the master terminal 10.

The step 42 of signaling, to a user of at least one terminal, of a pairing, signals to the users of the master terminal 10 and of the supervision terminal 20 a successful pairing by means of the signaling means 103 and 203 respectively. The signaling step 42 occurs just after the pairing step.

The step 43 of encryption of the presence signal from a supervision terminal 20 is configured to encrypt each presence signal to be emitted by said supervision terminal 20 and guarantee the confidentiality of the exchanges between the supervision terminal 20 and the master terminal 10. The encryption step is ensured by the encryption means 214 of the supervision terminal 20.

The step 44 of emission by each supervision terminal 20 paired with the master terminal 10 of a presence signal at a determined frequency is ensured by the emission means 216 of each supervision terminal 20. The emission of the presence signal can be performed on wave frequencies corresponding to ultrasounds or to DECT ULE for example. The encryption step 43 and the emission step 44 are implemented straight after the pairing of the supervision terminal 20 with the master terminal 10.

The step 45 of retransmission by a supervision terminal 20 of a presence signal emitted by another supervision terminal 20-2 is a possible case. The step 45 is implemented by the supervision terminal 20 when the supervision terminal 20-2 is out of range of the master terminal 10. The presence signal from the terminal 20-2 is transmitted to the supervision terminal 20 which retransmits without modifying the presence signal from the supervision terminal 20-2 to the master terminal 10.

The steps 44 of emission and 45 of retransmission are followed by the detection step 46 performed by the master terminal 10. The step 46 of detection by the master terminal 10 of the presence signal emitted by each supervision terminal 20 is implemented by the detection means 105 of the master terminal 10. The detection step 46 can comprise the following substeps:
storage of each presence signal detected,
analysis of each presence signal detected and of the power of the presence signal detected.

The step 47 of comparison of a power of a presence signal from each supervision terminal 20 detected with at least one predetermined limit value is configured to determine a distance of the user of the supervision terminal 20 from the user of the master terminal 10. Each predetermined limit value can correspond to a zone of distance from the master terminal 10. Several predetermined limit values can be defined such that:
if the power of the presence signal is greater than seventy five percent of the value of the power of the initial presence signal, the user of the supervision terminal having emitted the presence signal is considered to be in the near zone,
if the power of the presence signal is between fifty and seventy five percent of the value of the power of the initial presence signal, the user of the supervision terminal having emitted the presence signal is considered to be in the far zone,
if the power of the presence signal is below fifty percent of the value of the power of the initial presence signal, the user of the supervision terminal having emitted the presence signal is considered to be in the zone limit,
if the presence signal is not detected, the supervision terminal is considered to be absent.

Once each comparison is made, the master terminal 10 implements the step 48 of informing of a user of the master terminal 10 of a power of a presence signal from at least one supervision terminal 20 lower than at least one predetermined limit value. The user of the master terminal 10 can be informed of the distance to each supervision terminal 20 paired with the master terminal 10.

The informed user can proceed with a step 49 of management of the master terminal 10 and of at least one supervision terminal 20 by a communicating portable terminal 307. The management step 49 can comprise the following substeps:
pairing of the master terminal 10 with the communicating portable terminal 307 operating in a way similar to the step of pairing between the master terminal 10 and a supervision terminal 20,
emission of at least one request to the master terminal or a supervision terminal consisting, for example, in emitting is a command to modify the emission frequency of said supervision terminal, a sound or light signal emission command, a command to detect the heart rate of the user of said supervision terminal, a command to detect the speed or the acceleration of said supervision terminal, a command to detect the level of charge of the standalone power source of said terminal,
creation of at least one visual or sound alert as a function of at least one result of the comparison step 47,
modification of at least one predetermined limit value,
changing of at least one frequency of emission of a presence signal by a supervision terminal 20,
management of the administration data of the master terminal 10 or of at least one supervision terminal 20.

The management step 49 can be performed by means of an application.

The management step 49 can control a step 50 of establishment of a telephone call between the master terminal 10 and at least one supervision terminal 20 or a step 51 of collection of data required by the master terminal 10 and obtained by at least one supervision terminal 20 for example.

The step 50 of establishment of a telephone call between the master terminal 10 and at least one supervision terminal 20 can be implemented by the user of the master terminal. The establishment of a telephone call is configured for the user of the master terminal to be able to communicate directly with a user of a supervision terminal when the power of the presence signal from said supervision terminal is low for example.

The step 51 of collection of data required by the master terminal 10 and obtained by at least one supervision terminal 20 can be configured to collect data from at least one sensor 211 of the supervision terminal 20. The data picked up can be a heart rate, an acceleration of the supervision terminal 20, a speed of displacement of the supervision terminal 20, a local datum such as a temperature or a pressure for example. The collection step 51 can be implemented by the master terminal 10.

The management step 49 can be concurrent with the step 52 of display of at least one information item contained in at least one presence signal detected by the master terminal 10. The display step 52 can be implemented by a screen of the communicating portable terminal.

The steps 45, 46, 47, 48, 49, 50, 51 and 52 can be performed in a different order.

1-12. (canceled)

13. A method for detecting at least one emission of a presence signal from at least one supervision terminal by a master terminal, comprising the steps of:
pairing of said at least one supervision terminal with the master terminal,
emission by each supervision terminal paired with the master terminal of a presence signal at a predetermined frequency, the presence signal from said each supervision terminal is a Digital Enhanced Cordless Telecommunications Ultra Low Energy (DECT ULE) signal;
detecting by the master terminal of the presence signal emitted by said each supervision terminal paired with the master terminal;
comparing a power of the detected presence signal from said each supervision terminal with at least one predetermined limit value; and
informing a user of the master terminal of the power of the presence signal from said at least one supervision terminal lower than said at least one predetermined limit value.

14. The method as claimed in claim 13, wherein the pairing step comprises a step of signaling to a user of at least one supervision terminal of a pairing.

15. The method as claimed in claim 13, further comprising a step of collecting data required by the master terminal and obtained by said at least one supervision terminal.

16. The method as claimed in claim 13, wherein the emission step comprises a step of retransmitting, by a supervision terminal, of a presence signal emitted by another supervision terminal.

17. The method as claimed in claim 13, further comprising a step of managing the master terminal or said at least one supervision terminal by a communicating portable terminal.

18. The method as claimed in claim 17, wherein the management step comprises a step of displaying at least one information item contained in at least one presence signal detected by the master terminal.

19. The method as claimed in claim 13, further comprising a step of establishing a telephone call between the master terminal and said at least one supervision terminal.

20. The method as claimed in claim 13, wherein the presence signal from said at least one supervision terminal comprises data collected by said at least one supervision terminal.

21. The method as claimed in claim 13, wherein the presence signal from said at least one supervision terminal comprises redundant information.

22. The method as claimed in claim 13, wherein the emission step comprises a step of encrypting the presence signal from said at least one supervision terminal.

23. A system to detect at least one emission of a presence signal from at least one supervision terminal by a master terminal,
wherein each supervision terminal comprising a pairing unit to pair said each supervision terminal with the master terminal and an emitter to emit a presence signal at a predetermined frequency, the presence signal from said each supervision terminal is a Digital Enhanced Cordless Telecommunications Ultra Low Energy (DECT ULE) signal; and
wherein the master terminal comprises:
a pairing unit to pair the master terminal with at least one supervision terminal;
a detector to detect the presence signal emitted by said each supervision terminal paired with the master terminal;
a processor to compare a power of the detected presence signal from each supervision terminal with at least one predetermined limit value; and
a display to inform a user of the master terminal of the power of the presence signal from said at least one supervision terminal lower than said at least one predetermined limit value.

24. The system of claim 23, wherein the detector is a modem and wherein the pairing unit is a transmitter/receiver.

25. A master terminal to supervise groups, comprising:
a pairing unit to pair the master terminal with at least one supervision terminal;
a detector to detect a presence signal emitted by each supervision terminal paired with the master terminal, the presence signal from said each supervision terminal is a Digital Enhanced Cordless Telecommunications Ultra Low Energy (DECT ULE) signal;
a processor to compare a power of the detected presence signal from said each supervision terminal with at least one predetermined limit value; and
a display to inform a user of the master terminal of the power of the presence signal from said at least one supervision terminal lower than said at least one predetermined limit value.

26. The system of claim 25, wherein the detector is a modem and wherein the pairing unit is a transmitter/receiver.
